(19) United States
(12) Patent Application Publication
(10) Pub. No.: US 2007/0116004 A1
(43) Pub. Date: May 24, 2007

(54) Method and apparatus for guaranteeing QoS using end-to-end CAC in internet service network

(76) Inventors: Kuk Chang Kang, Daejeon (KR); Soon Seok Lee, Daejeon (KR); Young Sun Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/503,339

(22) Filed: Aug. 11, 2006

(30) Foreign Application Priority Data
Nov. 22, 2005 (KR) 10-2005-0111792

(51) Int. Cl. H04L 12/56; H04L 12/28

(52) U.S. Cl. 370/395.2; 370/235

(57) ABSTRACT

Provided is a method and apparatus for guaranteeing QoS using end-to-end CAC in an Internet service network. The method includes the steps of: (a) performing a subscriber domain CAC by querying a subscriber DB to determine whether to admit a call based on available bandwidth information of a subscriber when a subscriber terminal requests resource reservation; (b) performing a network domain CAC by querying a resource DB based on a result of the subscriber domain CAC to determine whether a resource required for service can be reserved or not; and (c) updating reserved bandwidth information and available bandwidth information of a subscriber domain in the subscriber DB and resource use information of a network domain in the resource DB when the resource reservation is completed through the steps (a) and (b).

### CROSS-REFERENCE TO RELATED APPLICATION

This application claims priority to and the benefit of Korean Patent Application No. 2005-111792, filed Nov. 22, 2005, the disclosure of which is incorporated herein by reference in its entirety.

### BACKGROUND

1. Field of the Invention

The present invention relates to a method and apparatus for guaranteeing quality of service (QoS) using end-to-end call admission control (CAC) in an Internet service network, and more particularly, to a method and apparatus for guaranteeing QoS of Internet service using end-to-end CAC in an IP network having a structure for guaranteeing QoS by resource reservation.

2. Discussion of Related Art

An existing Internet service is provided in the form of a best effort type service whose quality depends on a network status regardless of quality requirement for corresponding service. However, in a next generation network (NGN), a premium level service which consistently guarantees a quality of each service is suggested.

The premium level service requires a certain amount of resources (i.e., guaranteed rate), and in order to guarantee QoS for the resources, the network should perform a call admission control (CAC) procedure which finds resources which can satisfy QoS requirement of each service, reserves the resources, and then admits a service request.

However, a conventional QoS guaranteeing method performs a CAC procedure by calculating an available resource in a network domain and comparing it with a requested resource. That is, only network domain CAC is considered, and a bandwidth resource of a subscriber line domain which is an environment in which a user accesses the network is not considered, and thus there is a problem in a service admission control and resource management method for end-to-end QoS. The conventional QoS guaranteeing method will be described in detail with reference to FIG. 1.

FIG. 1 is a schematic diagram illustrating a range of subscriber domain CAC, network domain CAC, and end-to-end CAC.

The CAC is a concept for allowing the network to admit a call or a service only when a resource capable of guaranteeing QoS of each service can be assigned. Many CAC procedures and resource reservation methods for guaranteeing QoS have been suggested.

However, as shown in FIG. 1, the conventional QoS guaranteeing method considers only a network domain 12 of an access node—a core nodes—an access node but does not consider a subscriber domain 11. That is, since the CAC procedure is performed only in a domain after the access node but is not performed in the subscriber domain, it is impossible to guarantee QoS only with the CAC which considers only the network domain in the service admission control and resource management method for QoS.

That is, in order to guarantee end-to-end QoS, it is necessary to first check whether a network access means of a service user can accommodate a bandwidth demand of a newly requested service or not. However, if a service is admitted since a network resource is enough even though a line bandwidth of a user side is not enough, it is impossible to guarantee QoS. Thus, there is a need for a CAC technique which considers an end-to-end domain 13 between user terminals in order to guarantee end-to-end QoS.

### SUMMARY OF THE INVENTION

The present invention is directed to a method and apparatus for guaranteeing end-to-end QoS for a guaranteed rate service having constant-level bandwidth requirement in a QoS-guaranteeing network by performing subscriber domain CAC based on an available bandwidth of a subscriber line domain and then performing network domain CAC for determining whether a resource of a network domain is available or not, that is, by performing a resource reservation procedure according to a service request and a resource release procedure according to service termination through end-to-end CAC which incorporates both the subscriber domain CAC and the network domain CAC.

One aspect of the present invention is to provide a method for guaranteeing end-to-end CAC in an Internet service network, the method comprising: (a) performing a subscriber domain CAC by querying a subscriber DB to determine whether to admit a call based on available bandwidth information of a subscriber when a subscriber terminal requests resource reservation; (b) performing a network domain CAC by querying a resource DB based on a result of the subscriber domain CAC to determine whether a resource required for service can be reserved or not; and (c) updating reserved bandwidth information and available bandwidth information of a subscriber domain in the subscriber DB and resource use information of a network domain in the resource DB when the resource reservation is completed through the steps (a) and (b).

Preferably, the method may further include the steps of: obtaining circuit ID information of a subscriber using a dynamic host configuration protocol (DHCP) packet; and recording and managing information about previously-reserved bandwidth and available bandwidth for the subscriber in the subscriber DB based on the obtained circuit ID information.

Preferably, the method may further include the steps of: when the subscriber terminal requests resource release, releasing the resource through network setting in response to the resource release request; and updating reserved bandwidth information and available bandwidth information in the subscriber DB and resource use information in the resource DB as the resource is released.

Preferably, the method may further comprise: a step of, when resource reservation is requested in a state that a caller and a callee are connected to the same network or different networks, perceiving a status of the callee to transmit a communicable service protocol in response to the caller's service request; performing a subscriber domain CAC by querying the subscriber DB for each of a caller side and a callee side to determine whether to admit a call based on available bandwidth information of the caller and callee; and performing a network domain CAC by querying the resource DB for each of the caller and callee sides based on the subscriber domain CAC result to determine whether a resource required for service can be reserved.

Preferably, the method may further include a step of, when the resource reservation is completed by the subscriber domain CAC and the network domain CAC, updating reserved bandwidth information and available bandwidth information of each of the caller and callee in the subscriber DB and resource use information in the resource DB

Preferably, the method may further include the steps of: when resource release is requested in a state that the caller and callee are connected to the same network or different networks, releasing the resource through network setting in response to the resource release request; and updating reserved bandwidth information and available bandwidth information of each of the caller and callee in the subscriber DB and resource use information in the resource DB as the resource is released.

Another aspect of the present invention is to provide an apparatus for guaranteeing QoS using end-to-end CAC in an Internet service network, comprising: a service control function for performing subscriber domain CAC which queries a subscriber DB to determine whether to admit a call based on available bandwidth information of a subscriber when resource reservation is requested; and a network control function for performing network domain CAC which queries a resource DB according to the call admission determination result of the service control function to determine whether a resource required for service can be reserved or not, wherein the service control function updates reserved bandwidth information and available bandwidth information of a subscriber in the subscriber DB, and the network control function updates resource use information in the resource DB when the resource reservation is completed.

Preferably, the subscriber DB may include fields for subscriber ID information, circuit ID information, IP address information, contracted bandwidth information of a subscriber line, reserved bandwidth information of the scriber line, and available bandwidth information of the subscriber line.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a schematic diagram illustrating a range of subscriber domain CAC, network domain CAC, and end-to-end CAC;

FIG. 2 is a schematic diagram illustrating an end-to-end CAC procedure when a user requests resource reservation according to an embodiment of the present invention;

FIG. 3 is a flowchart illustrating a procedure for obtaining circuit ID information according to the present invention;

FIG. 4 shows a subscriber DB having an improved structure according to the present invention;

FIG. 5 is a flowchart illustrating an end-to-end CAC procedure when a user requests resource reservation according to the present invention;

FIG. 6 is a flowchart illustrating end-to-end CAC when the service reservation is requested in a state that a caller and a callee are connected to the same network;

FIG. 7 is a flowchart illustrating an end-to-end CAC procedure when the resource reservation is requested in a state that the caller and callee are connected to different networks;

FIG. 8 is a flowchart illustrating an end-to-end resource release procedure when a user requests resource release according to the present invention;

FIG. 9 is a flowchart illustrating an end-to-end resource release procedure when the resource release is requested in a state that the caller and the callee are connected to the same network; and

FIG. 10 is a flowchart illustrating an end-to-end resource release procedure when the resource release is requested in a state that the caller and the callee are connected to different networks.

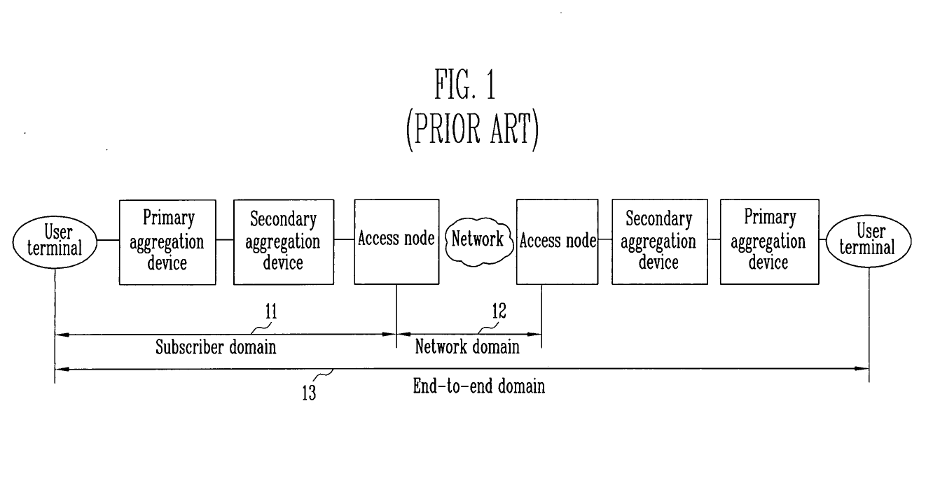

### DETAILED DESCRIPTION OF PREFERRED EMBODIMENTS

Hereinafter, an exemplary embodiment of the present invention will be described in detail. However, the present invention is not limited to the embodiments disclosed below, but can be implemented in various types. Therefore, the present embodiment is provided for complete disclosure of the present invention and to fully inform the scope of the present invention to those ordinarily skilled in the art.

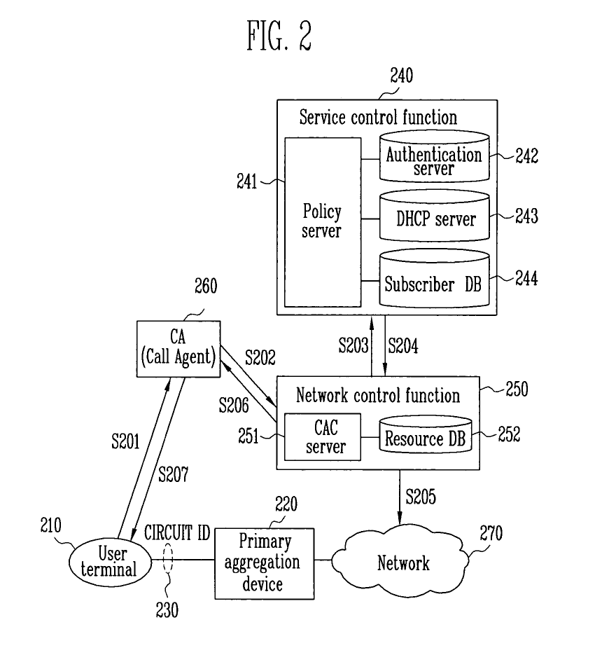

FIG. 2 is a schematic diagram illustrating an end-to-end CAC procedure when a user requests resource reservation according to an embodiment of the present invention.

As shown in FIG. 2, the present invention can be applied to a QoS guaranteeing network which includes a user terminal 210 such as a DSL modem or a cable modem, a primary aggregation device 220 such as digital subscriber line access multiplexer (DSLAM) or cable modem termination system (CMTS), a subscriber line 230 for connecting the subscriber terminal 210 to the primary aggregation device 220, a service control function 240 for performing functions related to a service, a service level agreement (SLA) and a subscriber-related policy, a network control function 250 for controlling network resources, a call agent (CA) 260 for receiving a service request from a user and relaying it for an IP communication service between users, and an IP network 270 having a function for reserving a network resource for a guaranteed rate service which requires a certain bandwidth in advance to thereby guarantee QoS.

The service control function 240 preferably includes a policy server 241 for performing a subscriber-related policy function, an authentication server 242 for performing user authentication, a dynamic host configuration protocol (DHCP) server 243 for allocating an IP address, and a subscriber DB 244 for managing subscriber-related information. The network control function 250 preferably includes a CAC server 251 and a resource DB 252 for managing network resources.

In the QoS guaranteeing network of FIG. 2, in order to guarantee an end-to-end QoS, an end-to-end CAC concept which considers both the subscriber domain CAC and the network domain CAC is introduced. The network domain CAC may be performed by the same method as the convention CAC procedure, but a new CAC procedure for the subscriber domain CAC is needed.

That is, a call should be admitted only when a resource can be reserved in order to guarantee the end-to-end QoS. To this end, it is necessary to manage information about a previously-reserved (i.e., allocated) bandwidth and an available bandwidth which can be additionally reserved (i.e., allocated) in a subscriber access line unit.

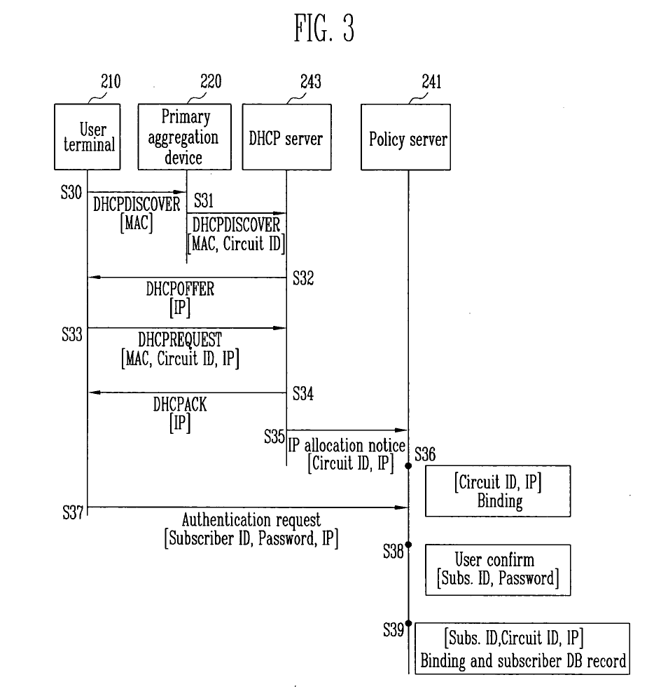

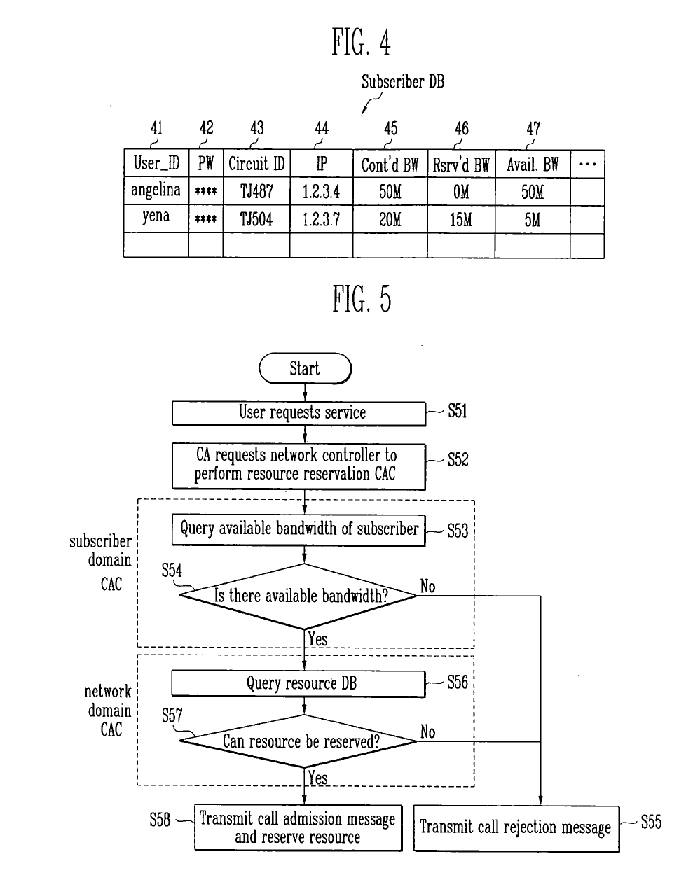

To this end, a bandwidth resource of an end user is managed by the subscriber DB 244 in which a circuit ID for identifying the subscriber line 230 which is a network access means of a user and an IP address of a service user are bound together to be stored. The circuit ID and the subscriber DB will be described later with reference to FIGS. 3 and 4 and thus are briefly described below.

The circuit ID is an identifier unique to the subscriber line 230, which connects the subscriber terminal 210 such as the DSL modem or the cable modem to the primary aggregation device 220 such as DSLAM or CMTS. In the present invention, the subscriber line is substantially identical to an access line of the user. Preferably, the circuit ID unique to each subscriber line is allocated when the user subscribes to the network operator for the first time.

The unique circuit ID information allocated to the subscriber line is obtained when the user first connects an IP terminal to the network 270 to be allocated an IP from the DHCP server 243. A MAC address of the user terminal and the circuit ID information are transmitted together in the procedure that the user terminal requests allocation of the IP address, and the policy server 241 binds the allocated IP address with the circuit ID to record them in the subscriber DB 244.

The circuit ID and the subscriber ID are bound in the authentication procedure performed by the authentication server 242, and the bound information is recorded in the subscriber DB 244. The supplemental information necessary for the present invention can be managed by a separate storage, while the existing subscriber DB is maintained as it is. However, it is assumed that the supplemental information is managed by the subscriber. DB having an improved structure for description convenience.

Meanwhile, when CA 260 receives a service request from the service user 210 (S201), the CA 260 finds the other communication party and the requested service standard and requests resource reservation to the network control function 250 (S202). The network control function 250 performs subscriber domain CAC for checking whether the subscriber side has an available bandwidth (S203 and S204) and then performs network domain CAC for checking whether a resource can be allocated in the network, in order to inform the user of whether to admit a call (S205 to S207). The procedure briefly described above will be described below in detail.

First, when requesting resource reservation to the network control function 250 (S202), the CA 260 transmits an IP address of a caller, an IP address of a callee, and QoS information to the network control function 250. The network control function 250 performs the subscriber domain CAC (S203 and S204), which queries to the service control function 240 whether the subscriber side has an available bandwidth based on the information transmitted from the CA 260 and receives a response thereto.

Here, in the step S203 in which the network control function 250 requests the subscriber domain CAC to the service control function 240, the network control function 250 should send the IP information of the caller and requested bandwidth information of a corresponding service to the service control function 240, and the service control function 240 determines whether to admit a call by referring to the subscriber DB 244 in response to the subscriber domain CAC query from the network control function 250. The requested bandwidth of the service is compared to the available bandwidth in the subscriber DB 244, and the call is admitted when the available bandwidth is greater than the requested bandwidth of the service. A determination result as to whether to admit a call is transmitted to the network control function 250 (S204).

Next, the network control function 250 queries the resource DB 252 through the CAC server 251 to check whether a resource of the network side can be reserved or not, and it performs the network domain CAC for reserving the resource when a resource of the network side can be reserved (S205).

The network control function 250 transmits a determination result as to whether to admit a call (whether the resource can be reserved) to the CA 260 to thereby inform the user of whether to admit a call (S206 and S207).

In order to guarantee the end-to-end QoS, it is necessary to first check whether the network access means of the service user can accommodate the bandwidth demand of a newly requested service or not. The present invention first performs the subscriber domain CAC based on the available bandwidth of the subscriber domain and then performs the network domain CAC which determines whether the resource of the network domain can be reserved or not. The service is provided to the user when the resource for satisfying the QoS demand can be allocated, thereby guaranteeing the end-to-end QoS as to the guaranteed-rate service.

Thus, the resource reservation responsive to the service request is performed through the end-to-end CAC procedure which incorporates both the subscriber domain CAC and the network domain CAC, thereby guaranteeing the end-to-end QoS.

Meanwhile, a determination is made as to whether the user terminal can accommodate the bandwidth demand for the service based on the information about the subscriber line 230, which is the network access means of the user, i.e., the circuit ID information. This determination is used to manage the bandwidth resource of the end user. The method for obtaining the circuit ID will be now described with reference to FIG. 3.

FIG. 3 is a flowchart illustrating a procedure for obtaining the circuit ID information according to the present invention. In particular, FIG. 3 shows a method for obtaining the circuit ID information in the authentication and IP allocation procedures.

In FIG. 3, it is assumed that the circuit ID information is obtained when the IP address allocation is performed and then the subscriber authentication is performed. The method of obtaining and managing the circuit ID information is the same except for an execution order even when the subscriber authentication is performed and then the IP allocation is performed. Typically, the network operator allocates the subscriber ID unique to the subscriber line and manages the information about a physical location and line characteristics of the subscriber line together with the subscriber-related information.

In order to implement the present invention, the subscriber number (i.e., subscriber ID) unique to each subscriber line is allocated and is managed together with a contracted speed of each subscriber line. For example, a subscriber number is unique to the subscriber, and so it can be used as the circuit ID as it is.

Referring to FIG. 3, when the user turns on the user terminal to access the network, the DHCP client, i.e., the user terminal 210 transmits a DHCPDISCOVER message containing the MAC address (S30), and the primary aggregation device 220 adds the circuit ID information to the DHCPDISCOVER message and transmits the DHCPDISCOVER message containing the MAC address and the circuit ID information to the DHCP server 243 (S31).

That is, in the conventional network, the user transmits the MAC address to the DHCP server through the DHCP packet to get the IP address, but in the present invention, the circuit ID information is added to the DHCP packet together with the MAC address and then transmitted to the DHCP server 243.

Adding the MAC address and the circuit ID information to the DHCP packet is performed by inserting the circuit ID information into a client identifier which can be defined by an option field of the DHCP message, and this can be applied to the IPv4 and the IPv6.

The function for inserting the circuit ID information into the DHCP packet may belong to the user terminal 210 or the primary aggregation device 220. However, the user terminal 210 does not always access the same subscriber line due to the user mobility. Since the primary aggregation device 220 knows all of the subscriber lines, i.e., physical ports connected to itself and thus can identify the DHCP packet transmitted through each port to insert the circuit ID information into the DHCP packet, it is preferred that the primary aggregation device 220 has the function for adding the circuit ID information to the DHCP packet.

Thereafter, the DHCP server 243 selects an appropriate IP address to respond with a DHCPOFFER message (S32), and the user terminal 210 confirms the IP address provided through the DCHPREQUEST (S33). The DHCP server 243 then transmits a DHCPACK message to confirm that allocation of the IP address has been completed (S34).

Meanwhile, the policy server 241 receives the allocated IP address and corresponding circuit ID information from the DHCP server 243, binds them together and temporarily stores them in a memory (S35 to S36). When the subscriber having the allocated the IP address sends the subscriber ID and the password to the policy server 241 for network authentication (S37), the policy server 241 retrieves the corresponding circuit ID information from the subscriber DB 244 to authenticate the subscriber terminal (S38), binds the circuit ID, the subscriber ID and the IP address together and records them in the subscriber DB 244 (S39).

By obtaining the information about the physical subscriber line of the service user through the circuit ID obtaining and binding procedures as described above, i.e., by obtaining the circuit ID information, it is possible to recognize whether the user terminal can accommodate the bandwidth demand for the service, whereby the subscriber domain CAC is ready to be performed.

While this embodiment has been described as performing the IP address allocation prior to the authentication, the authentication may be first performed and then the IP address may be allocated to only the authenticated subscribers. In such case, the subscriber ID information is obtained and then the circuit ID information and the IP address information are obtained during the IP address allocation. There is only a difference in a binding order with the circuit ID information. That is, the present invention can be applied to both cases, and the order of performing the authentication and the IP address allocation may depend on a policy of the network operator.

The typical subscriber DB includes a subscriber ID field, a password field, an IP address field, and so on. The subscriber DB 244 of the present invention is configured to manage information of pre-reserved bandwidth and available bandwidth that can be further reserved, in a unit of the subscriber line, in order to guarantee the end-to-end QoS. A configuration of the subscriber DB 244 according to the present invention will be described below with reference to FIG. 4.

FIG. 4 shows the subscriber DB having an improved structure according to the present invention. Fields for the circuit ID and the bandwidth use information of each user may be added to the typical subscriber DB.

As shown in FIG. 4, the subscriber DB 244 of the present invention includes a subscriber ID field (User_ID) 41, a password field (PW) 42, and an IP address field (IP) 44 and further includes a circuit ID field 43, which is an identifier of the access line, a contracted bandwidth (Cont'd BW) field 45, a reserved bandwidth (Rsrv'd BW) field 46, and an available bandwidth (Avail. BW) field 47, which are newly added.

That is, the circuit ID field 43, which is an identifier of the access line, and fields 45 to 47 for the contracted bandwidth, the reserved bandwidth field 46, and the available bandwidth, which are bandwidth use specification of a service user using the corresponding subscriber line, are newly added to the subscriber DB 244 to guarantee a QoS. The bandwidth use specification is modified in real time whenever each user newly uses or terminates a service, and thus, the information about the reserved bandwidth and the available bandwidth can be managed in a unit of the user access line, thereby guaranteeing the end-to-end QoS.

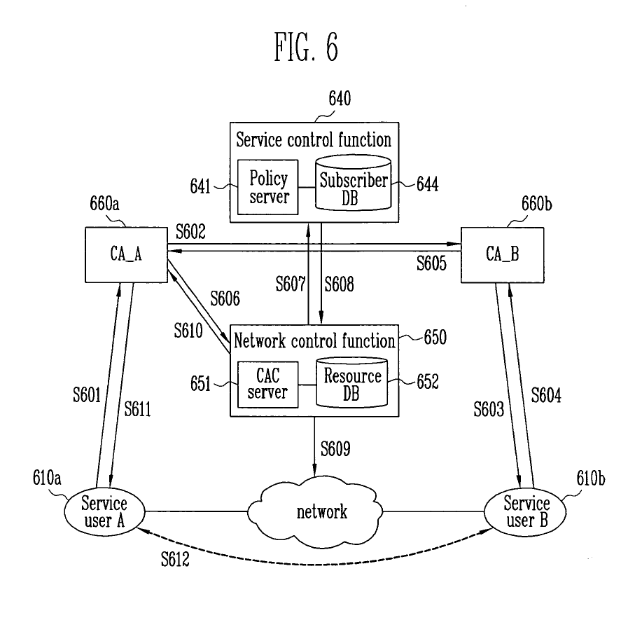

FIG. 5 is a flowchart illustrating an end-to-end CAC procedure according to the present invention, when the user requests resource reservation. In particular, FIG. 5 shows the end-to-end CAC procedure when the resource reservation is requested, after the IP allocation and user authentication procedures have been performed and the information about the bandwidth use of each user has been recorded in the subscriber DB 244 based on the circuit ID.

First, when an authenticated service user requests a service requiring a certain bandwidth to the CA 260 (S51), the CA 260 requests the network control function 250 to perform CAC (S52).

The network control function 250 performs the two-step CAC. In a first CAC step, which is the subscriber domain CAC step, the network control function 250 queries to the service control function 240 whether there is an available bandwidth to accommodate the service (S53), and the service control function 240 determines whether there is an available bandwidth for the requested service and notifies the network control function 250 of the determination result (S54).

When it is determined in step S54 that there is no available bandwidth, the network control function 250 transmits a call rejection message to the CA 260, and the CA 260 transmits the call rejection message to the service user (S55).

When it is determined in step S54 that there is an available bandwidth, the network control function 250 calculates a path required by the service to perform a second CAC step, which is the network domain CAC step, queries the resource DB 252 to check whether there is an available resource on the path (S56), and determines whether the resource required for the service can be reserved (S57).

When it is determined in step S57 that the resource reservation is possible, the network control function 250 reserves the resource through a network setting process and sends a call admission message to the CA 260 so that the call admission message is delivered to the user (S58).

When it is determined in step S57 that the resource reservation is impossible, i.e., when resource reservation fails, the network control function 250 transmits the call rejection message to the CA 260 so that the call rejection message is delivered to the service user (S55).

While the method for guaranteeing QoS of the service required by a user through the end-to-end CAC when a single user terminal connected to the network requests the resource has been described, the method for guaranteeing QoS of a service required by users connected to different networks through the end-to-end CAC will be now described.

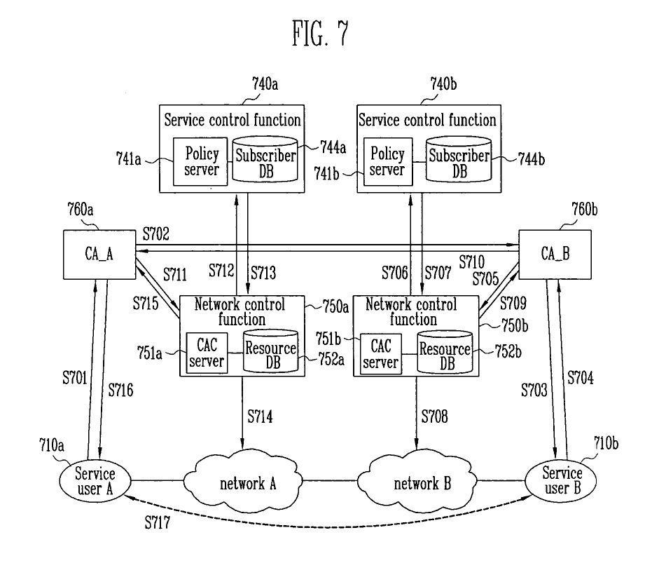

FIG. 6 is a flowchart illustrating end-to-end CAC when the resource reservation is requested in a state that a caller and a callee access the same network. In FIG. 6, a service user_A 610a is a caller, a service user_B 610b is a callee, and the service user_A 610a and user_B 610b are managed by different CAs.

First, the caller 610a requests a service to a CA_A 660a (S601), and the CA_A 660a perceives a location of the callee and transmits the service request to a called CA_B 660b to initiate service negotiation (S602). The CA_B 660b perceives a status of the callee 610b (S603 and S604) and transmits a communicable service protocol to the CA_A 660a (S605).

The CA_A 660a determines the bandwidth required for the service based on the negotiated service protocol to request the network control function 650 to perform the CAC (S606), and the network control function 650 queries the subscriber domain CAC to the service control function 640 and receives the response thereto (S607 and S608).

At this time, the service control function 640 should simultaneously perform the subscriber domain CAC for the caller side and the callee side by querying an available bandwidth of the caller side based on the IP address of the caller and querying an available bandwidth of the callee side based on the IP address of the callee.

The network control function 650 performs the network domain CAC and performs the resource reservation when the call admission is possible (S609), and notifies the CA_A 660a of the call admission result to transmit the call admission message to the caller (S610 and S611).

When the CA_A 660a transmits the call admission message to the caller (S611), the service is connected between the two users (S612), and the service control function 640 and the network control function 650 update information in the subscriber DB 644 and the resource DB 652 as the call admission is performed.

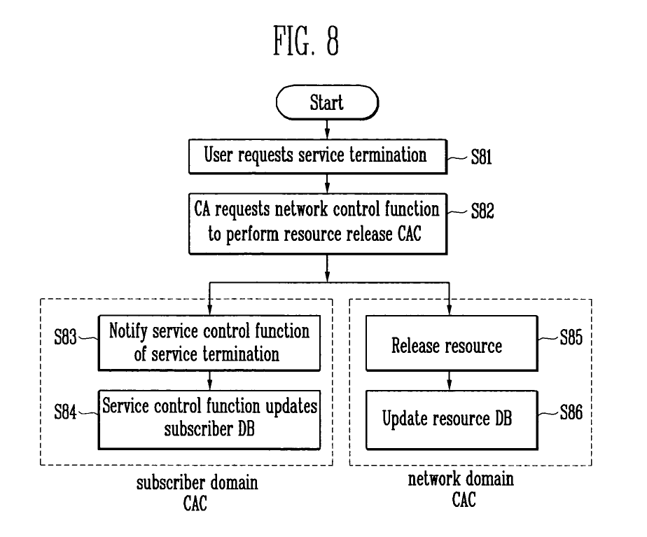

FIG. 7 is a flowchart illustrating end-to-end CAC when the resource reservation is requested in a state that the caller and the callee are connected to different networks. In FIG. 7, a service user A 710a is a caller, and a service user B 710b is a callee.

As shown in FIG. 7, when the caller and the callee are connected to different networks, respectively, the service negotiation between a CA_A 760a and a CA_B 760b is performed through the same process as in FIG. 6 (S701 to S704). But, unlike FIG. 6, the CA_B 760b first requests a network control function 750b at the callee side to perform the CAC (S705), and thus the network control function 750b at the callee side performs the subscriber domain CAC and the network domain CAC to determine whether to admit the call (S706 to S708).

Then, the network control function 750b at the callee side transmits a determination result as to whether to admit the call to the CA_B 760b at the callee side (S709), and when the call is admitted, the CA_B 706b at the callee side notifies the CA_A 760a at the caller side of the service negotiation result (S710).

Meanwhile, the calling CA_A 760a requests a network control function 750a at the caller side to perform the CAC based on the negotiated service protocol (S711), and the network control function 750a at the caller side performs the subscriber domain CAC and the network domain CAC for the caller side (S712 to S714) and notifies the CA_A 760a at the caller side of the call admission result when the call is admitted (S715). Thus, the call admission message is delivered to the caller (S716), connecting the service between the two users (S717).

Similarly to FIG. 6, when the service is connected between the caller and the callee, i.e., when the call is admitted according to the end-to-end CAC procedure, the service control function 740a and the network control function 750a at the caller side reflect it to update the information in the subscriber DB 744a and the resource DB 752a, and the service control function 740b and the network control function 750b at the callee side also reflect it to update the information in the subscriber DB 744b and the resource DB 752b.

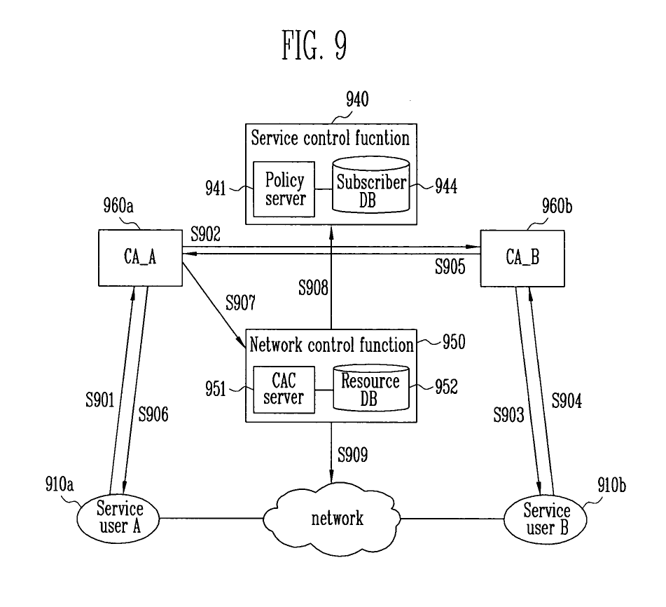

While the end-to-end CAC procedure for guaranteeing QoS upon requesting the resource reservation has been described, the present invention can guarantee QoS for subsequently requested service by performing the end-to-end resource releasing procedure to update the information in the subscriber DB and the resource DB. The end-to-end resource releasing procedure will be now described in detail with reference to FIGS. 8 to 10.

FIG. 8 is a flowchart illustrating the end-to-end resource release procedure when the user requests resource release according to the present invention. It is assumed, for convenience of explanation, that the end-to-end resource releasing procedure responsive to the resource release request is performed based on the network configured as in FIG. 2.

First, when the user terminal 210 requests the service termination to the CA 260 (S81), the CA 260 determines the bandwidth allocated to the service and requests the resource release by notifying the network control function 250 of the service termination (S82).

Then, the network control function 250 notifies the service control function 240 of the service termination (S83), and thus, the service control function 240 modifies an allocation specification of the bandwidth in the subscriber DB 244 (S84).

The network control function 250 releases the network resource allocated to the corresponding service (S85) and modifies the resource DB 252 (S86).

That is, when the user terminal 210 requests the service termination, the resource release procedure according to the service termination is performed to update the subscriber DB 244 and the resource DB 252. Thus, since the call is admitted only when the resource reservation is possible through the updated subscriber DB 244 and resource DB 252 even though the user requests a new service later, the end-to-end QoS can be guaranteed.

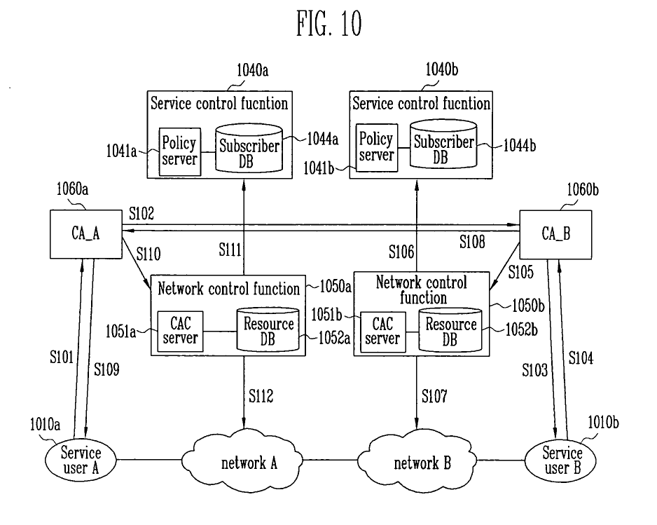

FIG. 9 is a flowchart illustrating the end-to-end resource release procedure when the resource release is requested in a state that the caller and the callee are connected to the same network. In FIG. 9, a service user A 910a is a caller, and a service user B 910b is a callee.

When the caller A 910a transmits a service termination message to a calling CA_A 960a (S901), the calling CA_A 960a transmits a service termination message to a called CA_B 960b (S902). Thus, the service termination message is delivered to a terminal of a callee B 910b, whereby the callee B terminates the service (S903 and S904).

Next, when the called CA_B 960b notifies the calling CA_A 960a of the service termination result (S905), the calling CA_A 960a confirms the service termination to the caller A 910a (S906) and at the same time notifies a network control function 950 of the service termination (S907). The network control function 950 transmits the service termination to a service control function 940 (S908), and the service control function 940 modifies an allocation specification of the bandwidth in a subscriber DB 944.

Meanwhile, the network control function 950 releases the network resource allocated to the corresponding service (S909) and modifies a resource DB 952.

In this case, the service control function 940 should simultaneously update the subscriber information of both the caller 910a and the callee 910b by updating the reserved bandwidth and the available bandwidth of the circuit ID of the caller 910a based on his/her IP address and updating the reserved bandwidth and the available bandwidth of the circuit ID of the callee 910b based on his/her IP address.

FIG. 10 is a flowchart illustrating the end-to-end resource release procedure when the resource release is requested in a state that the caller and the callee are connected to different networks. In FIG. 10, a service user A 1010a is a caller, and a service user B 1010b is a callee.

As shown in FIG. 10, when the caller 1010a and the callee 1010b are connected to different networks, the service termination message is transmitted by the same procedure as that of FIG. 9 (S101 to S104), and a CA_A 1060a at the caller side transmits the service termination message to a network control function 1050a at the caller side to induce the resource release (S110), and a CA_B 1060b at the callee side transmits the service termination message to a network control function 1050b at the callee side to induce the resource release (S105).

The process that the network control function 1050a and 1050b and the service control function 1040a and 1040b modify the resource DBs 1052a and 1052b and the subscriber DBs 1044a and 1044b is the same as that of FIG. 9 except that each control function updates information of the subscriber managed by the control function.

As described above, in order to implement the present invention, it is necessary to modify the primary aggregation device in software so that the circuit ID information is inserted into the DHCP packet in allocating the IP address of the user terminal. In addition, there is a need for a recording medium for managing the bandwidth use specification information based on the circuit ID. These requirements can be satisfied by a simple method, such as the use of a separate recording medium or the modification of an existing DB structure. Thus, it can be appreciated that the present invention can be implemented by upgrading existing equipment in software or improving the subscriber DB structure.

In other words, the present invention uses the existing DHCP packet as it is in transmitting circuit ID information and thus the use of a separate device or modification of the existing protocol is not required to implement the present invention. According to the present invention, the end-to-end CAC procedure includes only the subscriber domain CAC and the bandwidth information managing procedure, in addition to the conventional CAC procedure. This makes it possible to keep the conventional network CAC procedure as it is, and thus, the present invention can be easily applied to conventional network systems.

Further, according to the present invention, the circuit ID as a unique identifier is used to discriminate the physical access environment of the service user, and the bandwidth use specification of the subscriber domain is managed based on the circuit ID. In this manner, as the subscriber domain CAC which is not considered in the convention CAC method becomes possible, the bandwidth resource of both the subscriber domain and the network domain are searched in advance for the IP communication service having a certain bandwidth demand, and a call is admitted only when the resource reservation is possible, thereby guaranteeing the end-to-end service QoS.

Meanwhile, the embodiments of the present invention described above can be provided in the form of a computer program and can be executed by the digital computer through the computer readable recording medium.

The computer readable recording medium includes a magnetic storage medium (e.g., ROM, floppy disk, hard disk, etc.), an optical readable medium (e.g., CD ROM, DVD, etc.), and a carrier wave (e.g., transmission via the Internet).

As described above, the present invention performs the subscriber domain CAC based on the available bandwidth of each subscriber line domain and then performs the network domain CAC for determining whether the resource is available in the network domain or not, thereby guaranteeing the end-to-end QoS for the service having a certain bandwidth demand in the QoS guaranteeing network.

Furthermore, the present invention suggests a method of utilizing the existing DHCP packet as it is in transmitting circuit ID information and a method of managing information about a bandwidth use specification based on a circuit ID through simple modification of an existing subscriber DB structure. Thus, the use of a separate device or modification of the protocol is not required to implement the present invention. According to the present invention, the end-to-end CAC procedure includes only the subscriber domain CAC and the bandwidth information managing procedure, in addition to the conventional CAC procedure. This makes it possible to keep the conventional network CAC procedure and thus the present invention can be easily applied to conventional network systems.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for guaranteeing QoS using end-to-end call admission control (CAC) in an Internet service network, the method comprising the steps of:
(a) performing a subscriber domain CAC by querying a subscriber DB to determine whether to admit a call based on available bandwidth information of a subscriber when a subscriber terminal requests resource reservation;
(b) performing a network domain CAC by querying a resource DB based on a result of the subscriber domain CAC to determine whether a resource required for service can be reserved or not; and
(c) updating reserved bandwidth information and available bandwidth information of a subscriber domain in the subscriber DB and resource use information of a network domain in the resource DB, when the resource reservation is completed through the steps (a) and (b).

2. The method of claim 1, further comprising the steps of:
(d) obtaining circuit ID information of a subscriber using a dynamic host configuration protocol (DHCP) packet; and
(e) recording and managing information about previously-reserved bandwidth and available bandwidth for the subscriber in the subscriber DB based on the obtained circuit ID information.

3. The method of claim 2, wherein step (d) comprises:
a first step of inserting a MAC address of a subscriber terminal and the circuit ID information into the DHCP packet to transmit the DHCP packet to a DHCP server;
a second step of, by the DHCP server, allocating an IP address;
a third step of binding the allocated IP address with the corresponding circuit ID information to temporarily store them in a memory; and
a fourth step of binding a subscriber ID obtained in a network authentication process with the IP address and the circuit ID information to record them in the subscriber DB.

4. The method of claim 3, wherein the first step comprises a step of inserting the circuit ID information into a client identifier which is an option field of the DHCP packet to transmit the DHCP packet to the DHCP server.

5. The method of claim 1, further comprising steps of: when the subscriber terminal requests resource release,
releasing the resource through network setting in response to the resource release request; and
updating reserved bandwidth information and available bandwidth information in the subscriber DB and resource use information in the resource DB as the resource is released.

6. The method of claim 1, wherein step (a) comprises the steps of:
transmitting, by a call agent, IP address information of a subscriber and requested bandwidth information of a service to a network control function in response to the subscriber terminal's service request;
requesting, by the network control function, a service control function to perform the subscriber domain CAC based on the IP address information of the subscriber and the requested bandwidth information of the service;
determining, by the service control function, whether to admit a call depending on a remaining available bandwidth of a subscriber side by referring to the subscriber DB; and
transmitting the CAC result to the network control function.

7. The method of claim 1, wherein step (b) comprises the steps of:
calculating a path requested for a service;
querying the resource DB to determine whether a resource required for the service on the calculated path can be reserved or not; and
reserving the resource through network setting and transmitting a call admission message to the subscriber when it is determined that the resource reservation is possible.

8. The method of claim 1, when resource reservation is requested in a state that a caller and a callee are connected to the same network or different networks, further comprising the steps of:
performing a subscriber domain CAC by querying the subscriber DB for each of a caller side and a callee side to determine whether to admit a call based on available bandwidth information of the caller and the callee; and
performing a network domain CAC by querying the resource DB for each of the caller and the callee sides based on the subscriber domain CAC result to determine whether a resource required for service can be reserved.

9. The method of claim 8, further comprising a step of, when the resource reservation is completed by the subscriber domain CAC performing step and the network domain CAC performing step, updating reserved bandwidth information and available bandwidth information of each of the caller and the callee in the subscriber DB and resource use information in the resource DB

10. The method of claim 1, when resource release is requested in a state that the caller and the callee are connected to the same network or different networks, further comprising the steps of:
releasing the resource through network setting in response to the resource release request; and
updating reserved bandwidth information and available bandwidth information of each of the caller and the callee in the subscriber DB and resource use information in the resource DB as the resource is released.

11. An apparatus for guaranteeing QoS using end-to-end CAC in an Internet service network, comprising:
a service control function for performing subscriber domain CAC which queries a subscriber DB to determine whether to admit a call based on available bandwidth information of a subscriber when resource reservation is requested; and
a network control function for performing network domain CAC which queries a resource DB according to the call admission determination result of the service control function to determine whether a resource required for service can be reserved or not,
wherein the service control function updates reserved bandwidth information and available bandwidth information of a subscriber in the subscriber DB, and the network control function updates resource use information in the resource DB when the resource reservation is completed.

12. The apparatus of claim 11, wherein the service control function comprises a DHCP server for allocating an IP address; and
when a DHCP packet containing a MAC address and circuit ID information is received from a subscriber terminal, the DHCP server allocates an IP address and binds the allocated IP address with corresponding circuit ID information to temporarily store them in a memory.

13. The apparatus of claim 12, wherein the circuit ID information is inserted into a client identifier which is an option field of the DHCP packet and then transmitted to the DHCP server.

14. The apparatus of claim 11, wherein the subscriber DB comprises fields for:
subscriber ID information,
circuit ID information,
IP address information,
contracted bandwidth information of a subscriber line,
reserved bandwidth information of the scriber line, and
available bandwidth information of the subscriber line.
